(19) United States
(12) Patent Application Publication
(10) Pub. No.: US 2008/0126920 A1
(43) Pub. Date: May 29, 2008

(54) Method for creating FMEA sheet and device for automatically creating FMEA sheet

(75) Inventors: Keiji Otaka, Nara-shi (JP); Toshihiro Moriya, Nara-shi (JP); Soichiro Kita, Nara-shi (JP); Akira Nakajima, Otsu-shi (JP); Hidefumi Konishi, Fukuchiyama-shi (JP); Masayoshi Abe, Ayabe-shi (JP); Hideki Yachiku, Osaka-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/907,667

(22) Filed: Oct. 16, 2007

(30) Foreign Application Priority Data
Oct. 19, 2006 (JP) 2006-285017

(51) Int. Cl. G06F 17/27

(52) U.S. Cl. 715/200

(57) ABSTRACT

An method for creating an FMEA sheet includes the steps of, retrieving a plurality of documents, dividing words in each of the plurality of retrieved documents into a plurality of morpheme words by morphological analysis, calculating a co-occurrence frequency of each of the plurality of morpheme words, generating a co-occurrence frequency network with morpheme words having a greater co-occurrence frequency than a predetermined level in the plurality of morpheme words, grouping the plurality of documents using the co-occurrence frequency network, extracting a word same as an FMEA word registered in an FMEA word concept dictionary created in advance from each of the plurality of documents belonging to a same group as a word to be used in creating the FMEA sheet and substituting the extracted word to the FMEA sheet.

### BACKGROUND OF THE INVENTION

1. Field of the Invention

The present invention relates to a method for creating an FMEA (failure mode effect analysis) to extract failure mode and perform effect analysis thereof, and a device for automatically creating an FMEA sheet.

2. Description of the Related Art

An FMEA, which is a reliability analysis method, is an abbreviation for Failure Mode and Effect Analysis, and refers to the failure mode and the effect analysis thereof. The FMEA includes design FMEA, step FMEA, and the like. The design FMEA relates to the failure mode in manufacturing and design for ensuring reliability by analyzing the effect the failure mode has on the product, and predicting and picking out potential failures and defects to prevent failures and defects in advance, whereas the step FMEA ensures reliability of the steps by analyzing the cause and mechanism of the occurrence of failure in the manufacturing steps to improve the steps.

With reference to the JIS standard term, “failure” means losing a set function, and “failure mode” refers to the category according to the form of failure state.

Such the FMEA enhances the reliability by successively making small improvements in design and in step, where the tabulated form thereof is an FMEA sheet. The FMEA sheet is preferably a sheet related to all the failure modes from which the necessity of the measure can be rapidly (concurrently) judged, and the reliability of the design and the step can be ensured.

Such FMEA sheet is convenient if automatically created, and a device therefor has been developed.

However, it is difficult to handle data that does not comply with the specification (data format) defined in the relevant device such as natural language documents in the conventional device, and furthermore, a task of inputting enormous amount of data along the data input specification of the relevant device requires a great amount of work for workers not familiar with handling of the device, and the created content of the FMEA sheet may differ depending on the level of skill of the FMRA sheet creator.

The document serving as a conventional art of the present invention is Japanese Laid-Open Patent Publication No. 2005-182544.

### SUMMARY OF THE INVENTION

In accordance with one aspect of the present invention, a method for creating the FMEA sheet includes the steps of, retrieving a plurality of documents, dividing words in each of the plurality of retrieved documents into a plurality of morpheme words by morphological analysis, calculating a co-occurrence frequency of each of the plurality of morpheme words in each of the plurality of documents, generating a co-occurrence frequency network with morpheme words having a greater co-occurrence frequency than a predetermined level in the plurality of morpheme words, grouping the plurality of documents using the co-occurrence frequency network, extracting a word same as an FMEA word registered in an FMEA word concept dictionary created in advance from each of the plurality of documents belonging to a same group as a word to be used in creating the FMEA sheet and substituting the extracted word to the FMEA sheet.

The term morpheme is a minimum linguistic unit that has a meaning.

The term co-occurrence refers to when a plurality of linguistic phenomena arises in the same linguistic environment such as speech, sentence, and context.

A dictionary registered with words used for the FMEA and words indicating the concept to which such words belong is preferable for the FMEA word concept dictionary.

In accordance with one aspect of the present invention, a computer readable medium storing a program to execute the method for creating an FMEA sheet according to claim 1 is provided.

In accordance with one aspect of the present invention, a device for automatically creating an FMEA sheet includes a memory for storing the program according to claim 2, a database storing the FMEA sheet, a CPU for executing the program, and an operation screen for user operation.

### BRIEF DESCRIPTION OF THE DRAWINGS

FIG. 1 shows a view of steps of a method for creating an FMEA sheet according to an embodiment of the present invention;

FIG. 2 shows a view of an example of retrieving documents of an arbitrary format to a device for automatically creating the FMEA sheet;

FIG. 3 shows a view of a step of performing morphological analysis by a morphological analyzing unit using a morphological analysis dictionary from the document;

FIG. 4 shows a view of a step of creating a co-occurrence frequency table using a co-occurrence frequency calculating unit from a plurality of documents;

FIG. 5 shows a view of a table of number of appeared documents for every word in step of FIG. 4;

FIG. 6 shows a view of a table of number of appeared documents for every combination of two words in step of FIG. 4;

FIG. 7 shows a view of the co-occurrence frequency table;

FIG. 8 shows a view of a step of creating a co-occurrence frequency network using a co-occurrence frequency network generating unit from the co-occurrence frequency table;

FIG. 9 shows a view of a configuration of a document categorizing unit;

FIG. 10 shows a view of document 1 and document 3;

FIG. 11 shows a view of a step of extracting words from the documents of the same group using the FMEA word concept dictionary by a word extracting unit;

FIG. 12A shows a view of an initial FMEA sheet, 12B shows the FMEA sheet and word group to be substituted to the FMEA sheet, and 12C shows a view of the created FMEA sheet;

FIG. 13 shows a view of a step of creating the FMEA sheet using the FMEA sheet database by an FMEA sheet generating unit;

FIG. 14 shows a view of a configuration of the FMEA sheet creating device;

FIG. 15 shows a view of an operation screen of the FMEA sheet creating device;

FIG. 16 shows a view of an operation screen of the FMEA sheet creating device input with the document;

FIG. 17 shows a view of an operation screen of the FMEA sheet creating device showing the dictionary selecting state;

FIG. 18 shows a view of an operation screen of the FMEA sheet creating device showing a state in which the FMEA sheet is selected; and

FIG. 19 shows a view of an FMEA sheet created by the FMEA sheet creating device.

### DETAILED DESCRIPTION OF THE PREFERRED EMBODIMENTS

A method for creating an FMEA sheet according to an embodiment of the present invention will now be described in detail. A device for automatically creating the FMEA sheet that executes the method for creating the FMEA sheet includes various memories such as a CPU, a RAM, a ROM, and hard disc drive, a display device, and an input device such as keyboard and mouse, similar to a general all-purpose personal computer. In such device for automatically creating the FMEA sheet, the CPU has a function for creating the FMEA sheet and a program for executing the creation of the FMEA sheet is stored in the memory. The program enables the CPU to execute steps n1 to n7, to be hereinafter described. The display device includes an operation screen for a user, and displays a screen for creating the FMEA sheet according to the input operation of the input device such as mouse and keyboard.

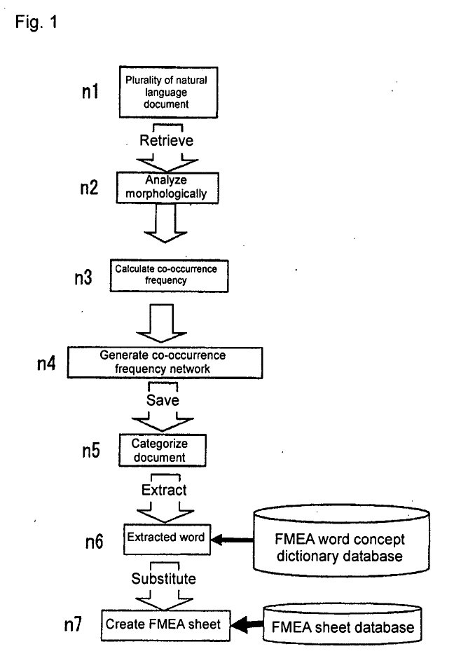

The device for automatically creating the FMEA sheet has a function of executing the flowchart of FIG. 1. In other words, the device for automatically creating the FMEA sheet has processing functions of retrieving documents, analyzing morphologically, calculating a co-occurrence frequency, generating a co-occurrence frequency network, categorizing the documents, extracting words, and creating the FMEA sheet, and also includes database of morphological analysis dictionary and the FMEA word concept dictionary, and database of the FMEA sheet as database.

The method for creating the FMEA sheet of the present embodiment will be described with reference to FIG. 1.

Schematically, the method for creating the FMEA sheet of the present invention includes

retrieving the natural language documents in step n1,

morphologically analyzing the documents and taking out a word in step n2,

calculating the co-occurrence frequency of each word taken out in step n3,

generating the co-occurrence frequency network in step n4,

categorizing the input documents based on the co-occurrence frequency network in step n5,

extracting a word contained in a concept to be used in the FMEA from the categorized documents from the database of the FMEA word concept dictionary in step n6, and

creating the FMEA sheet by substituting the extracted FMEA word to the FMEA sheet obtained in the FMEA sheet database in step n7.

The database of the FMEA word concept dictionary is registered with and stored with a plurality of types of words (registered words), and the concept words contained in the concept to which the registered word belongs in correspondence to each industry.

A style of various FMEA sheets is registered in the FMEA sheet database.

Each step n1 to n7 will now be described in detail.

(Step n1)

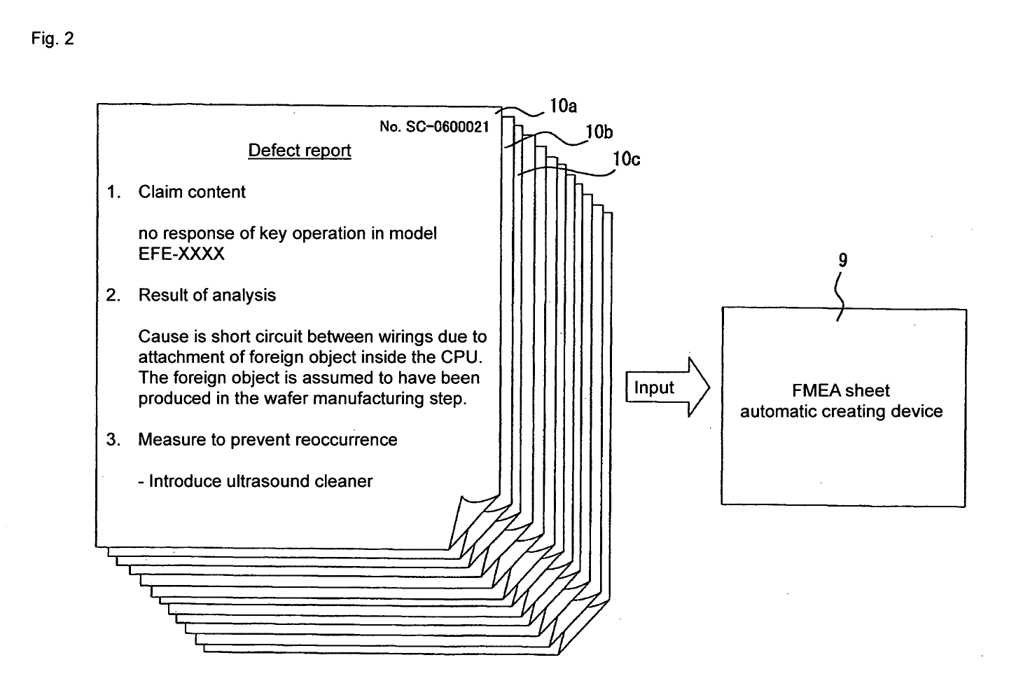

In step n1, documents (texts) 10a, 10b, 10c, of an arbitrary form as shown in FIG. 2 are retrieved into the device for automatically creating the FMEA sheet 9 configured by a computer. The method of retrieving the documents 10a, 10b, 10c, . . . into the device for automatically creating the FMEA sheet 9 is appropriately performed. For instance, the documents are retrieved into the computer through operation of the input device such as a mouse by the user. Alternatively, a CD-ROM or the like recorded with the documents may be set in the drive to be retrieved into the computer.

(Step n2)

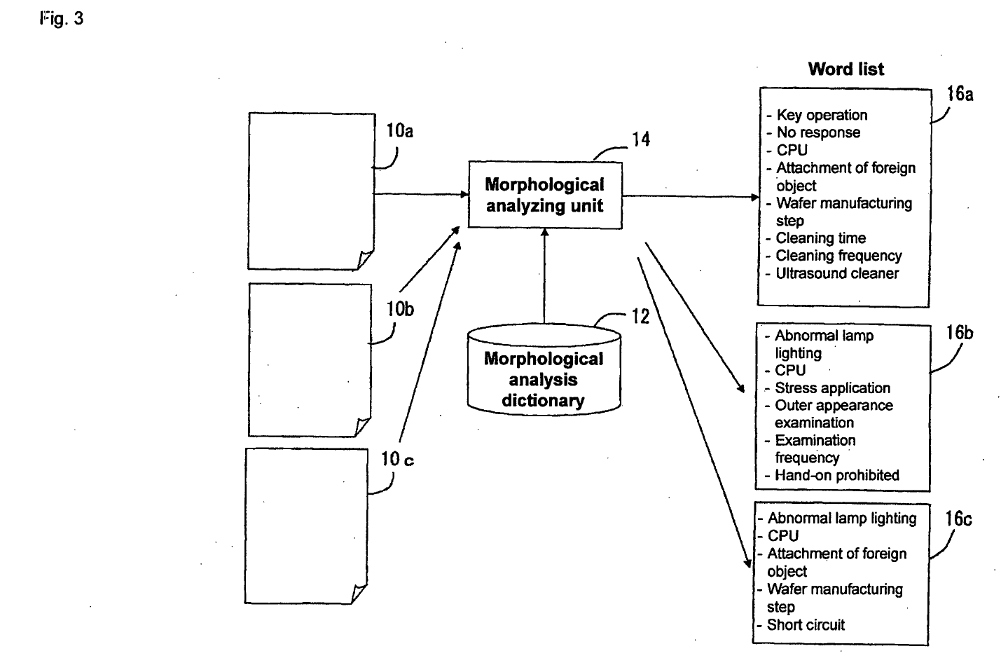

The morpheme words are taken out through morphological analysis as shown in FIG. 3 from the plurality of documents 10a, 10b, 10c, . . . retrieved in step n1. In the morphological analysis, a morphological analysis dictionary 12 and a morphological analyzing unit 14 are used.

The morphological analysis dictionary 12 is configured by the ROM or a storage device such as an EEPROM, a flexible disc, a CD-ROM, an MD, and the like. The morphological analysis dictionary 12 is created for the automobile industry if for the automobile industry, created for the electrical industry if for the electrical industry, and also for other various industries.

The morphological analyzing unit 14 is configured to morphologically analyze the documents 10a, 10b, 10c, . . . with reference to the morphological analysis dictionary 12.

Word lists 16a, 16b, 16c, . . . are created from the documents 10a, 10b, 10c, . . . analyzed morphologically by the morphological analyzing unit 14. The illustrated words are listed in the word lists 16a, 16b, 16c, . . . .

Morphological analysis is a natural language process using the morphological analyzing unit 14, and is a task of dividing the documents 10a, 10b, 10c, . . . into morpheme words. The morphological analyzing unit 14 performs the morphological analyzing task of the documents 10a, 10b, 10c, . . . with reference to the morphological analysis dictionary 12.

As apparent from comparing the document 10a of FIG. 2 and the word list 16a of FIG. 3 corresponding to the morphological analysis of the document 10a, the words listed in the word list 16a are “key operation”, “no response”, “CPU”, “attachment of foreign objects”, . . . “ultrasonic cleaner”, and not all the words in the document 10a are listed. The morphological analyzing unit 14 references the morphological analysis dictionary 12 when morphologically analyzing the words in the document 10a, and only the words related to the automobile industry if for the automobile industry or words related to the electrical industry if for the electrical industry are listed as a result of morphological analysis on the morpheme words stored and registered in the morphological analysis dictionary 12.

(Step n3)

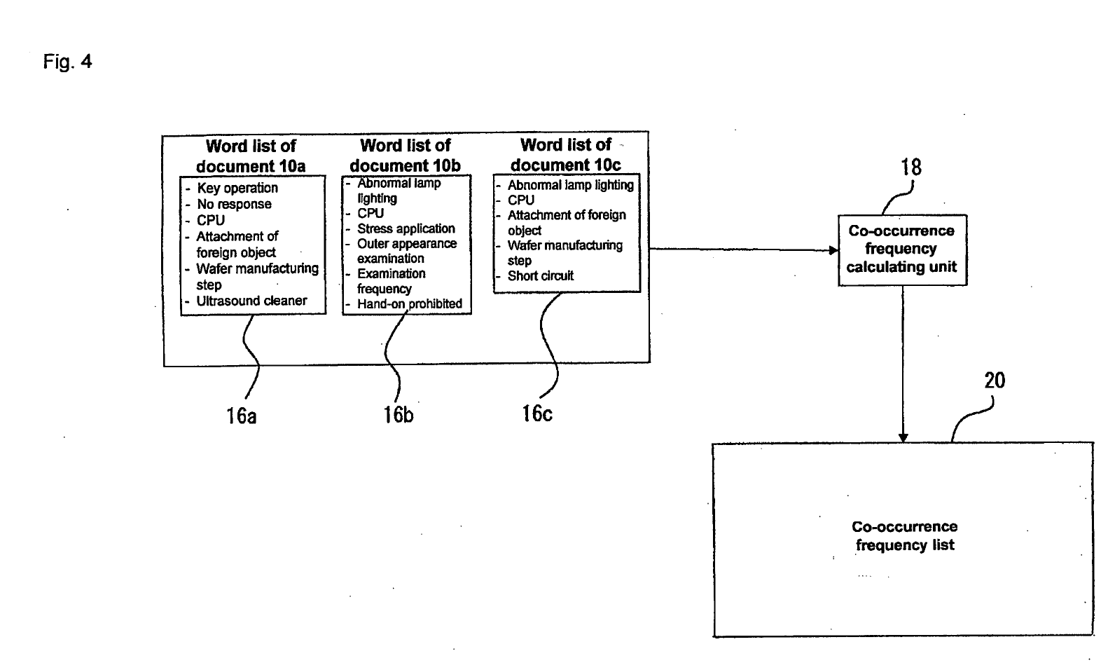

With reference to FIG. 4, the co-occurrence frequency is calculated in a co-occurrence frequency calculating unit 18 in step n3 with respect to the words in each document 10a, 10b, 10c, . . . morphologically analyzed in step 2 and listed in the word lists 16a, 16b, 16c, . . . , and the calculated co-occurrence frequency is written a co-occurrence frequency table 20.

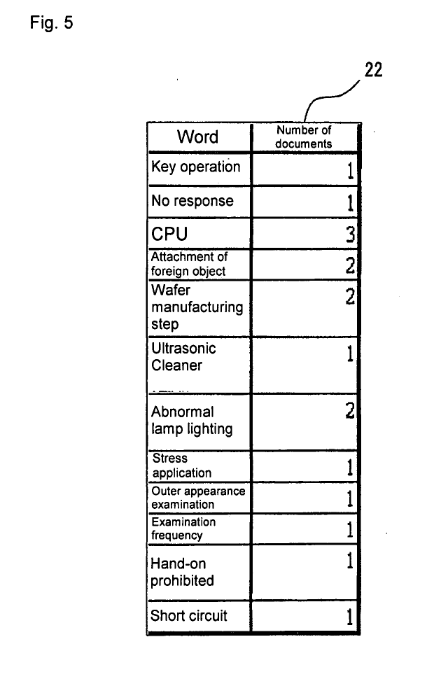

In this case, the co-occurrence frequency calculating unit 18 obtains number of documents that appears for every word with respect to the words listed in each word list 16a, 16b, 16c, as shown in a table 22 of FIG. 5. The left column of the table 22 is “word” and the right column is “number of documents”, where the number of documents in which the word “key operation” appears is “1” with respect to the word “key operation”, the number of documents in which the word “no response” appears is “1”, the number of documents in which the word “CPU” appears is “1”, the number of documents in which the word “attachment of foreign objects” appears is “1”, and so on.

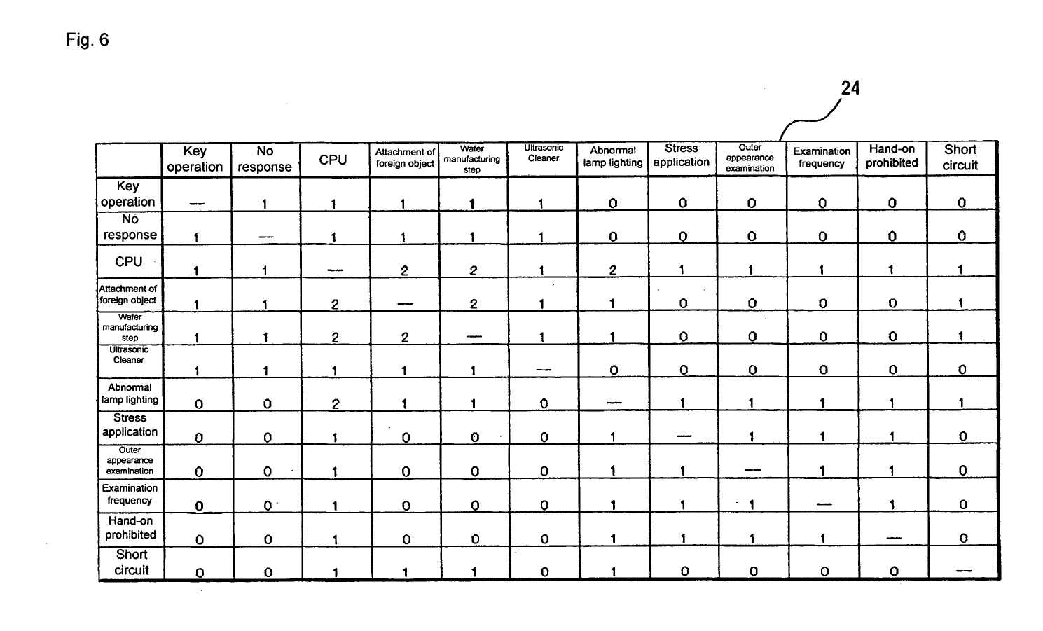

As shown in FIG. 6, the number of documents in which two arbitrary different words out of the words listed in each word list 16a, 16b, 16c, . . . simultaneously appear are summarized in table 24. In the table 24, the words are written in a field of one vertical column on a left end and a field of one horizontal row on an upper end, and the number of appeared documents is written in a cell at which the words intersect.

In this case, a field of one vertical column on the left end of the table 24 includes “key operation”, “no response”, “CPU”, etc. The field of one horizontal row on the upper end includes “key operation”, “no response”, “CPU” and the like. With respect to “key operation” of a first vertical column on a left field, the number of appeared documents of the two words of “key operation” and “no response” on an upper horizontal field is “1”, the number of appeared documents of the two words of “key operation” and “CPU” is “1”, and the number of appeared documents of the two words of “key operation” and “attachment of foreign objects” is “1”, and furthermore, with respect to “no response” of a second vertical column on the left field, the number of appeared documents of the two words of “no response” and “key operation” on the upper horizontal field is “1” and the number of appeared documents of the two words of “no response” and “CPU” is “1”, and the number of appeared documents of the two words of “no response” and “attachment of foreign objects” is “1”, and so on.

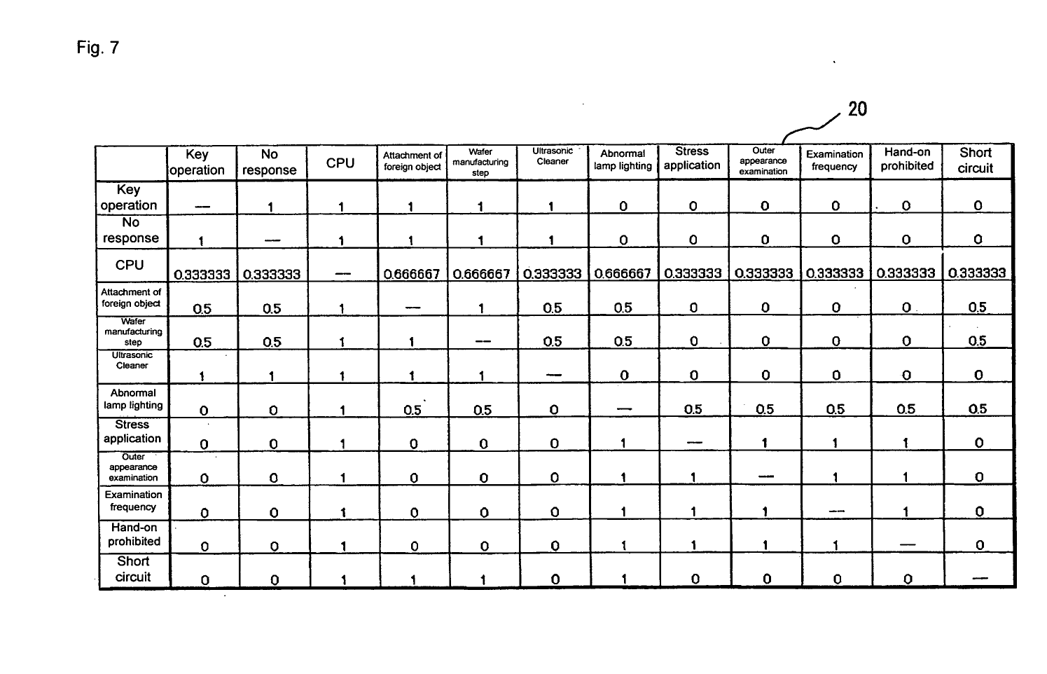

The number of appeared documents written in each cell of the co-occurrence table of FIG. 6 is divided by the number of documents obtained in FIG. 5 to obtain the co-occurrence frequency, and the co-occurrence frequency table 20 (see FIG. 4) as shown in FIG. 7 is obtained.

In other words, the equation is co-occurrence frequency=number of appeared documents/number of documents.

For instance, with respect to “key operation” of the first vertical column on the left field, the co-occurrence frequency of the two words of “key operation” and “no response” on the upper horizontal field is number of appeared documents 1 of FIG. 6/number of documents 1 of FIG. 5=“1”, the co-occurrence of two words of “key operation” and “CPU” is also “1”, the co-occurrence of two words of “key operation” and “attachment of foreign object” is also “1”, and furthermore, with respect to “no response” of the second vertical column on the left field, the co-occurrence of the two words of “no response” and “key operation” on the upper horizontal field is “1”, the co-occurrence of two words of “no response” and “CPU” is “1”, the co-occurrence of two words of “no response” and “attachment of foreign object” is “1”, and so on.

This is an example of calculating the co-occurrence frequency, and the calculation is not limited thereto.

(Step n4)

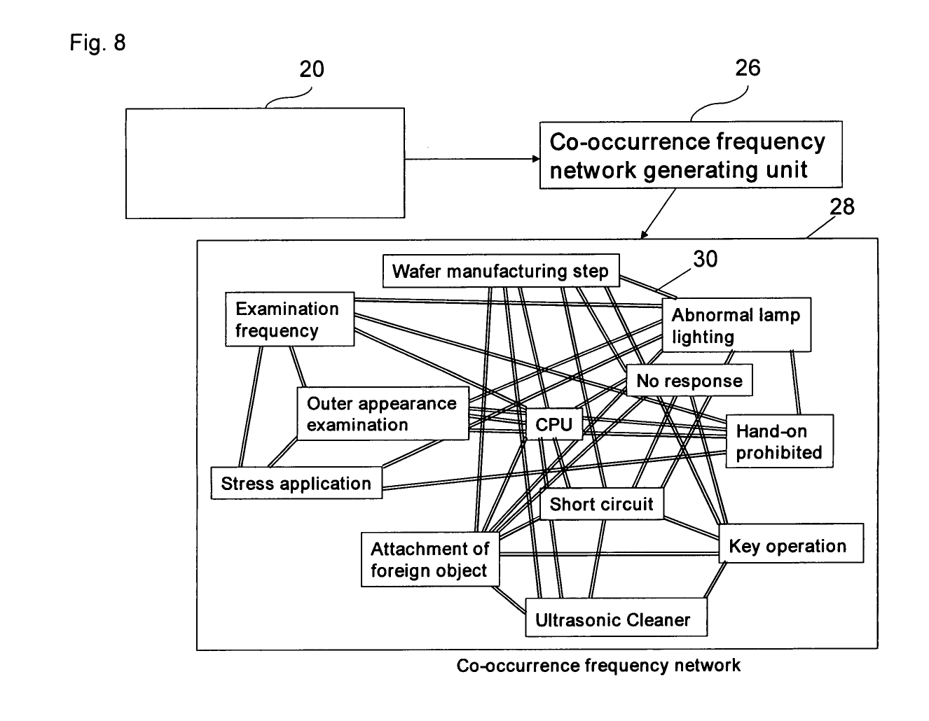

In step n4, a co-occurrence frequency network 28 is generated using a co-occurrence frequency network generating unit 26 from the co-occurrence frequency table 20 as shown in FIG. 8.

The co-occurrence frequency network 28 is a network generated by connecting morpheme words having a relationship of greater co-occurrence frequency than a predetermined level with a directed line 30 based on the co-occurrence frequency table 20.

In this network, the co-occurrence frequency is set to greater than or equal to 0.5 for the co-occurrence frequency relationship.

The co-occurrence frequency network generating unit 26 connects words having co-occurrence frequency of greater than or equal to 0.5 with the directed line 30 with reference to the co-occurrence frequency table 20.

The co-occurrence frequency between morpheme words connected by the directed line 30 is written on the directed line 30 shown in FIG. 8.

For instance, the words connected with “key operation” by the directed line 30 are “no response”, “wafer manufacturing step”, “short circuit”, and the like. The words connected with “no response” by the directed line 30 are “abnormal lamp lighting”, “wafer manufacturing step”, “CPU”, “short circuit”, and the like.

(Step n5)

Step n5 is a step of categorizing the documents by a document categorizing unit 32, where the document having the most or the least number of appeared words is selected from the documents 10a, 10b, 10c, . . . , and the selected document is assumed as a key document. For instance, the document to be categorized and judged is document 3 and the key document is document 1.

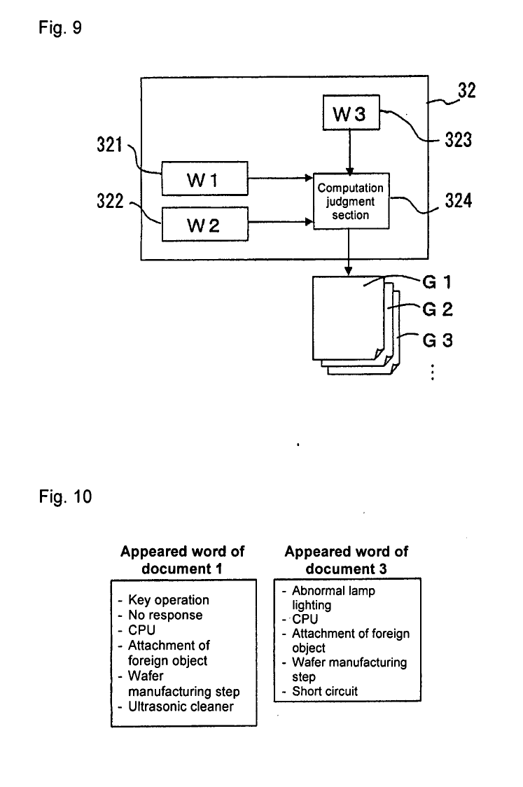

The document categorizing unit 32 shown in FIG. 9 is provided to perform step n5.

The document categorizing unit 32 is configured by a computing section 321 for computing the number of words w1 same as the word (key word) that appears in document 1, which is the key document, with respect to document 3, a computing section 322 for computing the number of words w2 connected on the co-occurrence frequency network with the key word with respect to document 3, a computing section 323 for computing a total number of appeared words w3 that appear in document 3, and a computation judgment section 324 for computing whether or not (w1+w2)/w3 is greater than or equal to X %, and then judging that document 3 is the same group as document 1 if greater than or equal to X % and grouping the relevant document.

Describing a procedure for judging whether or not document 1 and document 3 shown in FIG. 10 are in the same group when X=60% is set in the document categorizing unit 32. The appeared word in document 1 is six words, “key operation”, “no response”, “CPU”, “attachment of foreign object”, “wafer manufacturing step”, and “ultrasonic cleaner”. The appeared word in document 3 is five words, “abnormal lamp lighting”, “CPU”, “attachment of foreign object”, “wafer manufacturing step”, and “short circuit”.

The total number of appeared words w3 in document 3 is “5”, and thus the computed value w3 of the computing section 323 is w3=5.

The three appeared words “CPU”, “attachment of foreign object”, and “wafer manufacturing step n” in document 3 are the same words as the key words in document 1, and thus the number of same words w1 is “3” and the computed value w1 of the computing section 321 is w1=3.

The two appeared words “abnormal lamp lighting” and “short circuit” in document 3 are connected to the key words in document 1 with the directed line 30 on the co-occurrence frequency network, and thus the number of network words w2 connected in the co-occurrence frequency network is “2” and the computed value w2 of the computing section 322 is w2=3.

Therefore, X=(number w1 of same word+number w2 of network word)/(total number w3 of appeared words of document 3)=(3+2)/5=100% in the computation judgment section 324, and thus is greater than or equal to 60%, and document 3 is judged as group G1 same as document 1 (key document).

The above procedures are recursively applied for the remaining documents not considered to be in the same group as the key document.

G1, G2, . . . indicate group.

Each document is categorized in such manner.

The document used in generating the co-occurrence frequency network may be another document different from the document for categorization. The document having high reliability such as essay may be used to enhance the precision of related words.

Only the words having the directed line connected bi-directionally are assumed as the related words in the detection of related words from the co-occurrence frequency network. Although not directly connected, the word indirectly connected through some words may also be assumed as the related word.

Categorization may be carried out depending simply on how many of the same words are included without using the co-occurrence frequency network.

(Step n6)

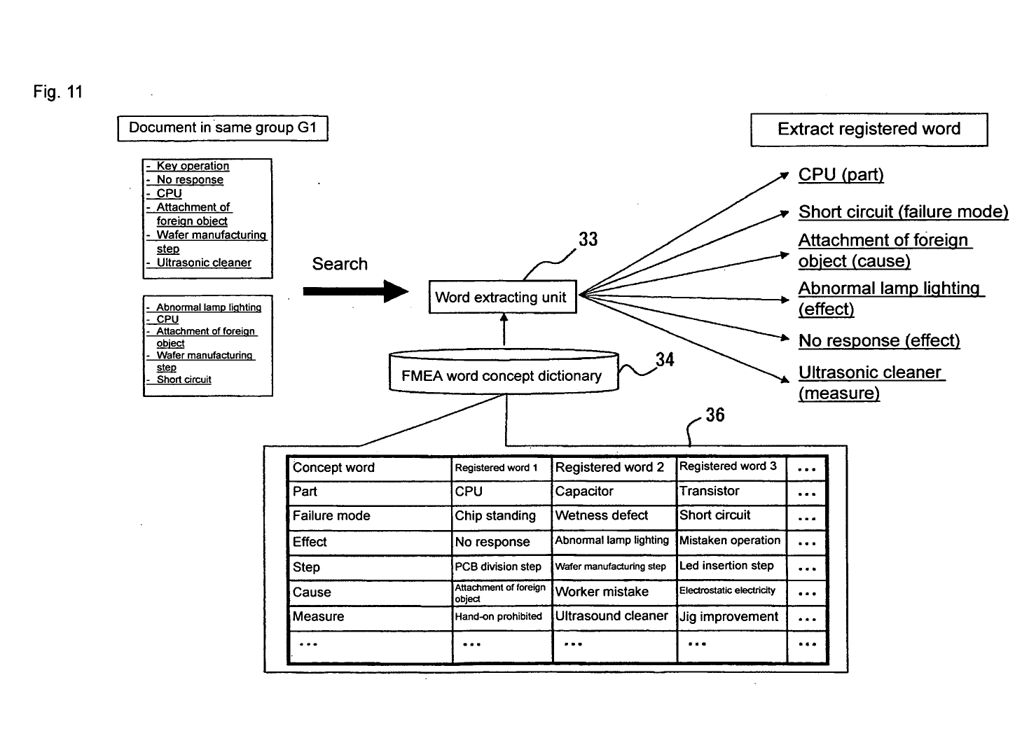

In step n6, the word contained in the concept used in the FMEA is extracted from the documents categorized in step n5. In step n6, a word extracting unit 33 and an FMEA word concept dictionary 34 are used as shown in FIG. 11.

The FMEA word concept dictionary 34 stores words (FMEA words) used in creating FMEA as registered words, and concept words indicating the concept to which the registered word belongs. A storage example of the FMEA word concept dictionary 34 is shown in a table 36.

The concept words, “part”, “failure mode”, “effect” etc. are written in one vertical column on the left end, and “registered word 1”, “registered word 2” etc. are written in one horizontal row on the upper end. The concept words are “part”, “failure mode”, “effect”, and the like.

The registered words 1, 2, 3 . . . with respect to the concept word “part” is “CPU”, “capacitor”, “transistor” . . . , and the registered words 1, 2, 3 . . . with respect to the concept word “failure mode” is “chip standing”, “wetness defect”, “short circuit” . . . .

The word extracting unit 33 references the FMEA word concept dictionary 34 with respect to documents 1 and 3 in the same group G1, and extracts registered words such as “CPU (part)”, “short circuit (failure mode”, “attachment of foreign object (cause)” from the table 36 in the FMEA word concept dictionary 34 with respect to “key operation”, “no response”, “CPU”, “attachment of foreign object”, “wafer manufacturing step”, “ultrasonic cleaner”, in document 1 and “abnormal lamp lighting”, “CPU”, “attachment of foreign object”, “wafer manufacturing step” and “short circuit” in document 3.

An example of creating the FMEA word concept dictionary 34 will be described, where the plurality of documents is divided into a plurality of morpheme words, the morpheme word that co-occurs from the FMEA word used in the FMEA is extraction processed as the co-occurrence word from the divided morpheme words, the FMEA word and the extracted co-occurrence word are stored in the database as registered words, and the resultant is created as the FMEA word concept dictionary. In this case, the concept word indicating the concept of the FMEA word belongs and the FMEA word are registered in association with each other.

The FMEA word concept dictionary 34 stores a plurality of types according to the type of industry, according to various technical fields, or according to other fields for database.

(Step n7)

In step n7, the FMEA sheet is created.

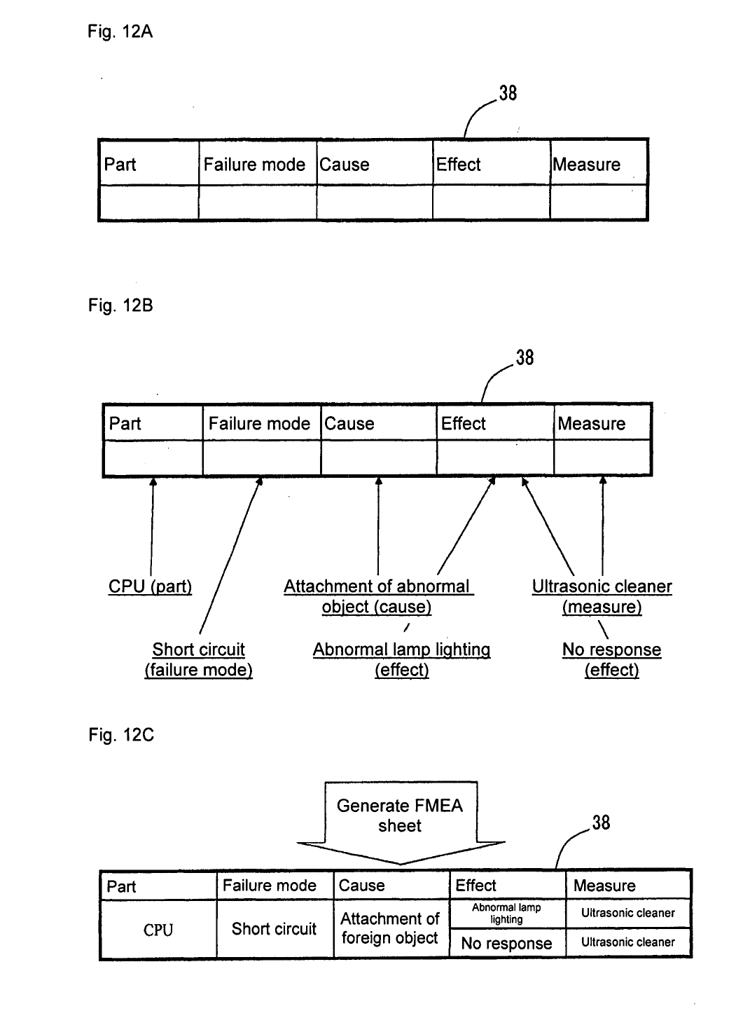

The initial FMEA sheet 38 of the step FMEA is shown in FIG. 12A. The categorizing items used in the FMEA, “part”, “failure mode”, “cause”, “effect”, “measure”, are displayed in the FMEA sheet 38.

As shown in FIG. 12B, if the categorizing items of the FMEA sheet 38 and the concept words shown in the table 36 of FIG. 11 are the same, the registered words extracted by the word extracting unit 33 are substituted to the FMEA sheet 38.

That is, the registered word “CPU (part)” extracted in step n6 is substituted to the categorizing item “part” of the initial FMEA sheet 38, the registered word “short circuit (failure mode)” is substituted to the categorizing item “failure mode”, the registered word “attachment of foreign object (cause)” is substituted to the categorizing item “cause”, the registered word “short circuit (abnormal lamp lighting (effect)” and “no response (effect)” are substituted to the categorizing item “effect”, and the registered word “ultrasonic cleaner (measure)” is substituted to the categorizing item “measure”.

As a result, the FMEA sheet 38 is created as shown in FIG. 12C.

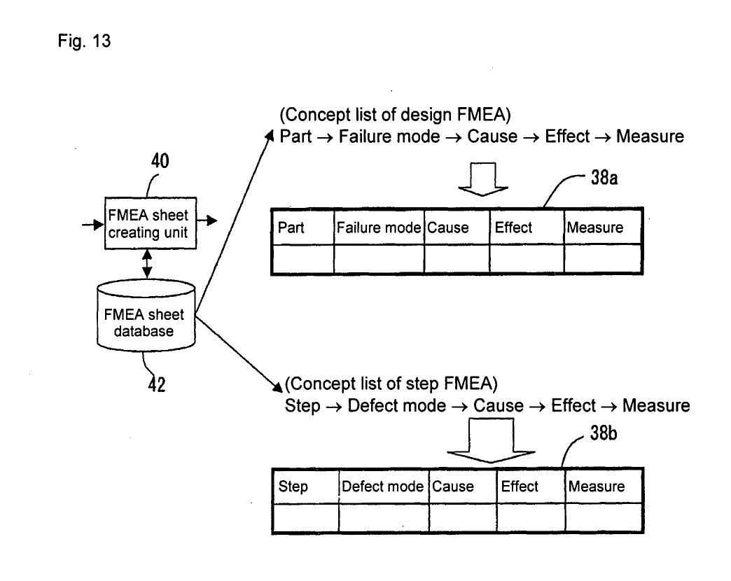

A specific example of the FMEA sheet database 42 is shown in FIG. 13. 40 is an FMEA sheet generating unit, and 42 is an FMEA sheet database. A design FMEA sheet 38a and a step FMEA sheet 38b are stored in the FMEA sheet database 42. The categorizing items of the FMEA sheets 38a, 38b are such in which the concept words of the table 36 are lined.

The design FMEA sheet 38a has the concept words lined in an order of part→failure mode→cause→effect→measure, and is stored in the FMEA sheet database 42 in such state.

The step FMEA sheet 38b has the concept words lined in an order of step→defect mode→cause→effect→measure, and is stored in the FEMA sheet database 42 in such state.

Therefore, the user can automatically create the FMEA sheet from the document of an arbitrary format such as natural language document, and the document to be performed with FMEA does not need to be converted to a dedicated format to create the FMEA sheet, whereby the FMEA sheet can be very easily created.

In addition, the FMEA sheet can be automatically created without requiring great amount of data to perform the FMEA.

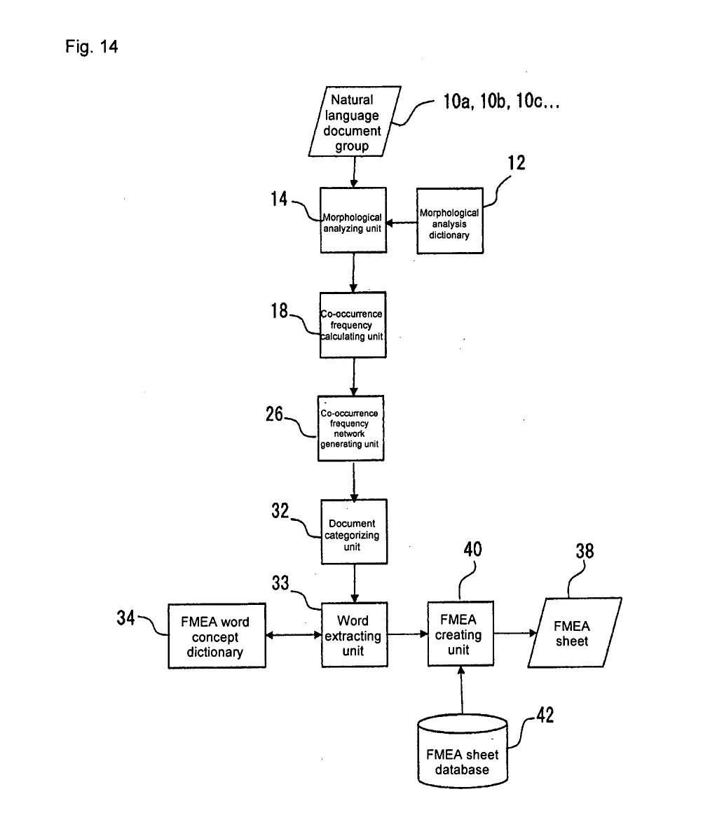

The functional block diagrams of the device for automatically creating the FMEA sheet to execute the method for creating the FMEA sheet described above is outlined in FIG. 14.

12 is the morphological analysis dictionary, 14 is the morphological analyzing unit, 18 is the co-occurrence frequency calculating unit, 26 is the co-occurrence frequency network generating unit, 32 is the document categorizing unit, 33 is the word extracting unit, 34 is the FMEA word concept dictionary, 40 is the FMEA generating unit, and 42 is the FMEA sheet database.

The FMEA word concept dictionary 34 uses that which stores a plurality of types of FMEA words for the database.

An example of the operation screen of the display device in the device for automatically creating the FMEA sheet having the above functions will be described below.

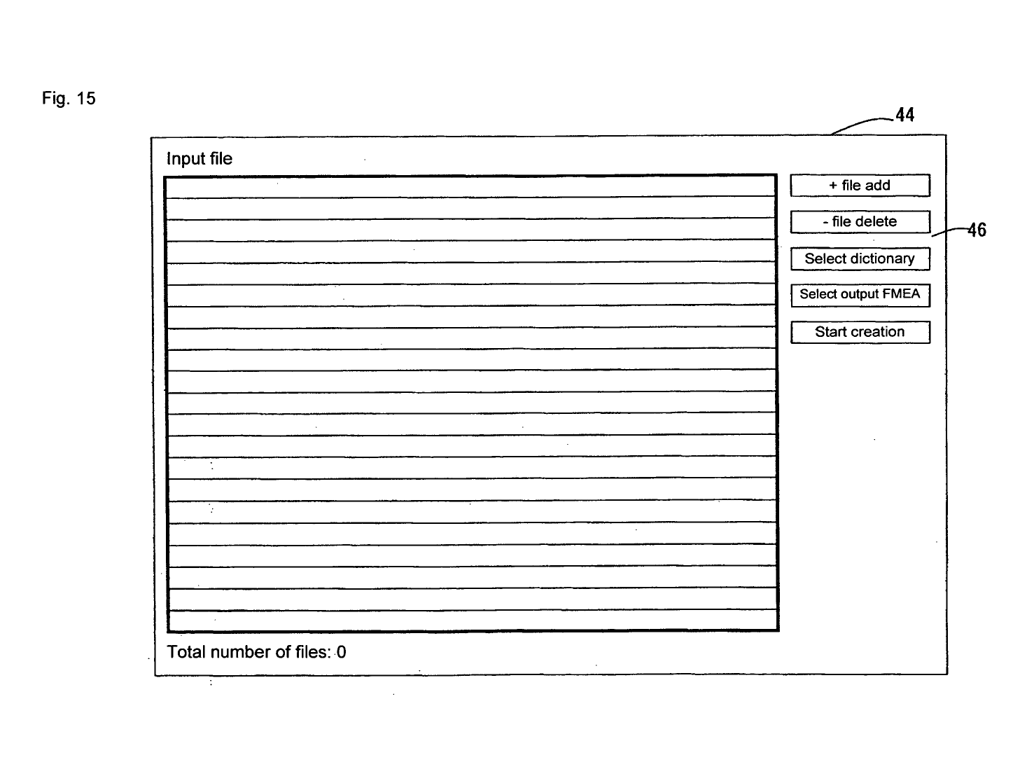

FIG. 15 shows an operation screen 44. A plurality of command buttons 46 are displayed in the operation screen 44. The command button 46 includes “+ file add”, “− file delete”, “select dictionary”, “select output FMEA”, and “start creation”. The “+ file add” and “− file delete” are command buttons that are operated when adding or deleting files.

The “select dictionary” is a command button that is operated when selecting the FMEA word concept dictionary.

The “select output FMEA” is a command button that is operated when selecting the FMEA sheet.

The “start creation” is a command button that is operated when starting the creation of the FMEA sheet.

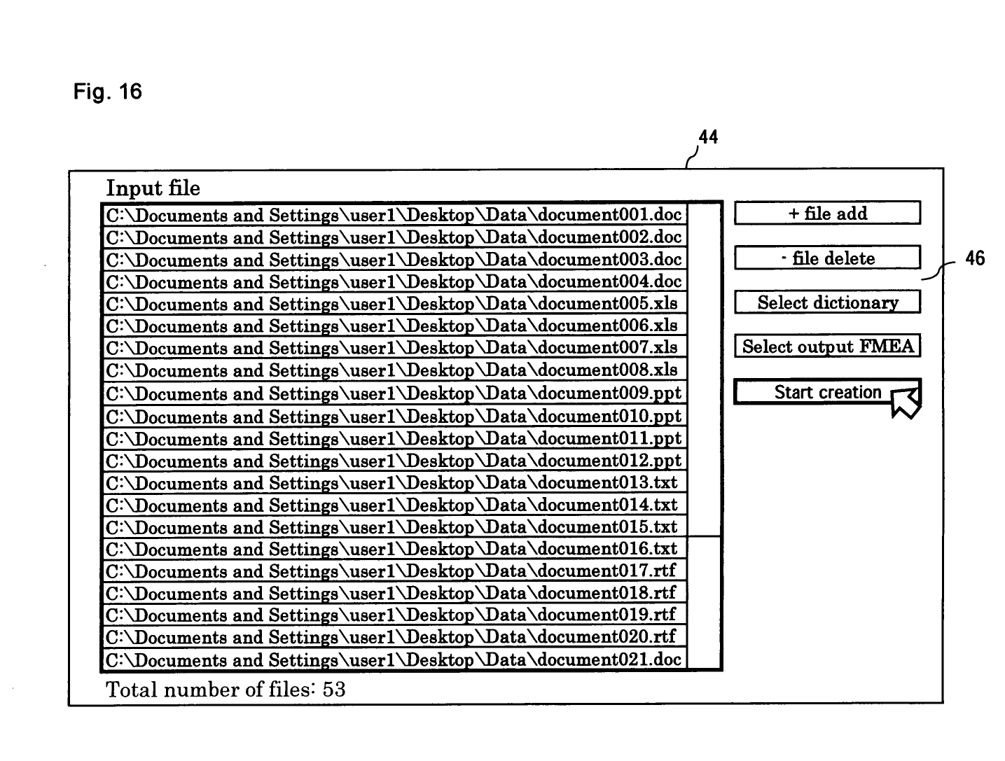

FIG. 16 shows a state of document input by operating the “start creation” command button to start the creation of the FMEA sheet on the operation screen 44. After operating the “start creation” command button, the FMEA sheet is automatically created.

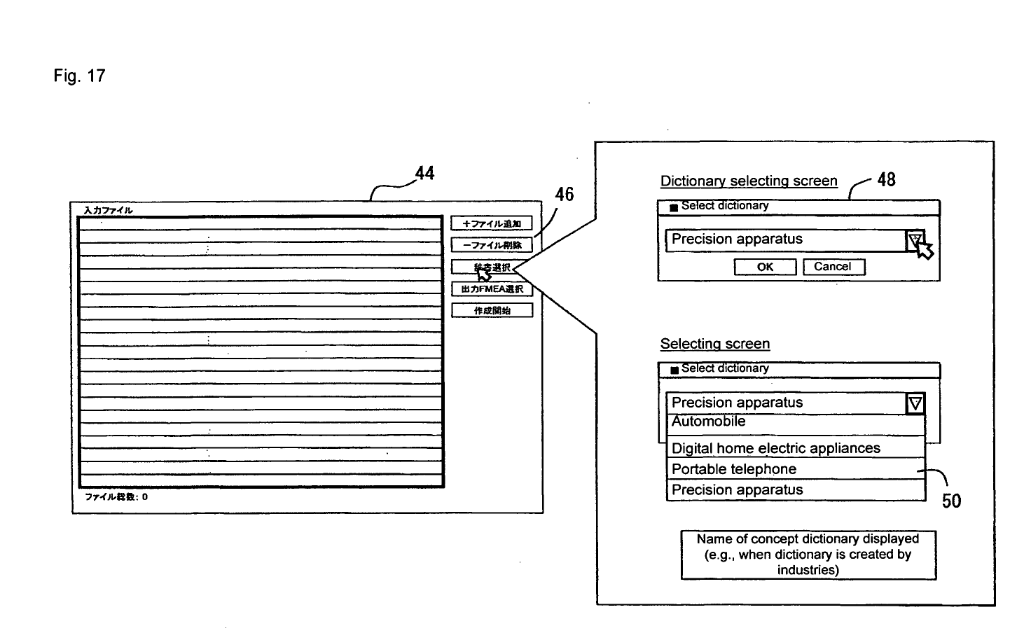

FIG. 17 shows an example of operating the “select dictionary” command button to selectively operate the FMEA word concept dictionary, where the relevant command button is operated to call out the selecting screen 48 of the FMEA word concept dictionary on the operation screen 44, select the combo box indicated by an arrow, and select an arbitrary FMEA word concept dictionary from a pull-down menu screen 50 for the FMEA word concept dictionary selection for each of a plurality of industries.

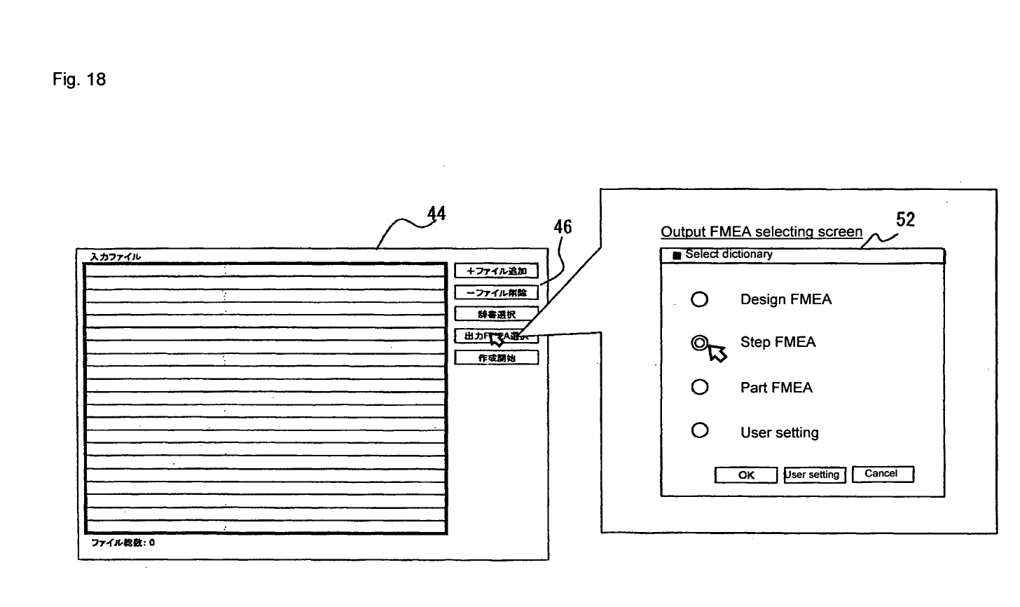

FIG. 18 shows an example of selecting the FMEA sheet, where the output FMEA selecting screen 52 is called out on the operation screen 44 by operating the “select output FMEA” command button. In the output FMEA selecting screen 52, a state in which the step FMEA is selected by a radio button is shown.

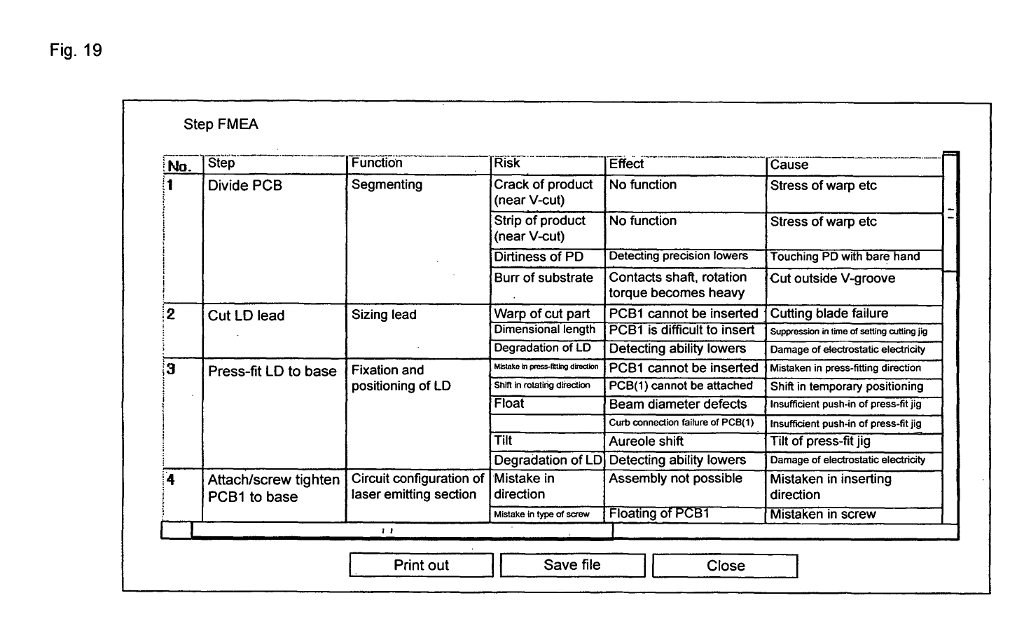

FIG. 19 shows a state in which the FMEA sheet is output on the operation screen 44.

The FMEA sheet can be printed out and stored.

Therefore, in the present embodiment, the FMEA sheet can be automatically created from the document of an arbitrary form, and the user does not need to convert the document to be performed with FMEA to a dedicated form to create the FMEA sheet, whereby the FMEA sheet can be very easily created. Furthermore, the FEMA sheet can be easily and automatically created without requiring great amount of data to perform the FMEA.

1. A method for creating an FMEA sheet, the method comprising the steps of:
retrieving a plurality of documents;
dividing words in each of the plurality of retrieved documents into a plurality of morpheme words by morphological analysis;
calculating a co-occurrence frequency of each of the plurality of morpheme words in each of the plurality of the documents;
generating a co-occurrence frequency network with morpheme words having a greater co-occurrence frequency than a predetermined level in the plurality of morpheme words;
grouping the plurality of documents using the co-occurrence frequency network;
extracting a word same as an FMEA word registered in an FMEA word concept dictionary created in advance from each of a plurality of documents belonging to a same group as a word to be used in creating the FMEA sheet; and
substituting the extracted word to the FMEA sheet.

2. A computer readable medium storing a program to execute the method for creating an FMEA sheet according to claim 1.

3. A device for automatically creating an FMEA sheet comprising:
a memory for storing the program according to claim 2;
a database storing the FMEA sheet;
a CPU for executing the program; and
an operation screen for user operation.

4. The device for automatically creating an FMEA sheet according to claim 3, further comprising:
a morphological analysis dictionary; and
an FMEA word concept dictionary.

5. The device for automatically creating an FMEA sheet according to claim 3, wherein command buttons which are operated by a user to create the FMEA sheet are arranged on the operation screen.
